(19) United States
(12) Patent Application Publication
(10) Pub. No.: US 2025/0330336 A1
(43) Pub. Date: Oct. 23, 2025

(54) OBTAINING A CHARACTERISTIC RESPONSE FROM A COMMUNICATIONS NETWORK DEVICE

(71) Applicant: British Telecommunications Public Limited Company, London (GB)

(72) Inventor: Catherine WHITE, London (GB)

(21) Appl. No.: 18/864,383

(22) PCT Filed: May 12, 2023
(86) PCT No.: PCT/EP2023/062849

§ 371 Date: Nov. 8, 2024

(30) Foreign Application Priority Data
May 12, 2022 (GB) 2206965.2
Jul. 13, 2022 (EP) 22184801.3

(51) Int. Cl. H04L 9/32

(52) U.S. Cl. CPC H04L 9/3278

(57) ABSTRACT

A method of obtaining a characteristic response from a communications network device in a communications network environment comprises accepting, at the communications network device, a challenge signal. Coupling all or part of the challenge signal or all or part of a transformation of the challenge signal in the form of radiation into one or more physical network channel media of the communication network. Allowing radiation to scatter between the physical communication channel media and a physically unclonable function PUF; and obtaining a response to the challenge by measuring scattered radiation from at least the PUF.

The present disclosure relates to obtaining a characteristic response from a communications network device which may be used for authenticating identity of the communications network device and authenticating an environment of the communications network device.

### BACKGROUND

Authenticating identity of a communications network device is typically done before establishing a secure communications channel with the communications network device. Authenticating identity of a communications network device comprises checking that the communications network device is the correct communications network device that it is desired to communicate with. This type of authentication helps guard against malicious parties who may have spoofed the communications network device.

Since a malicious party may have physical access to the communications network it is possible that a malicious party has tampered with an environment of the communications network device such as by tapping into communications links, spoofing nodes, inserting malicious nodes into the network, physically relocating the communications network device or other actions. The environment of the communications network device is the communications network elements (nodes and links) neighbouring the communications network device. Thus authenticating an environment of a communications network device is a way to improve security.

The examples described herein are not limited to examples which solve problems mentioned in this background section.

### SUMMARY

Examples of preferred aspects and embodiments of the invention are as set out in the accompanying independent and dependent claims.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A first aspect of the disclosed technology describes obtaining a characteristic response from a communications network device in a communications network environment, the method comprising: accepting, at the communications network device, a challenge signal; coupling all or part of the challenge signal or all or part of a transformation of the challenge signal in the form of radiation into one or more physical network channel media of the communication network; allowing radiation to scatter between the physical communication channel media and a physically unclonable function (PUF); and obtaining a response to the challenge by measuring scattered radiation from at least the PUF.

In some examples, where the radiation coupled into the one or more physical network channel media is all or part of a transformation of the challenge signal in the form of radiation, the transformation of the challenge signal in the form of radiation is obtained by scattering the radiation through the PUF before the challenge signal impinges on the physical communication channel media.

In some examples, where the radiation coupled into the one or more physical network channel media is all or part of a transformation of the challenge signal in the form of radiation, the transformation of the challenge signal in the form of radiation is obtained by scattering the radiation through an additional PUF.

In some examples the challenge signal is split into at least two parts, a first part of which is directly coupled to the PUF, and other parts of which are coupled to the environment, and the method comprises a scattered signal from the environment being coupled to the PUF.

In some examples the first part of the challenge signal and scattering from the other parts are coherent, and the response is influenced by classical or quantum interference between the first part of the challenge signal and scattering from the other parts.

In some examples validating the response is done by comparing the response to previous responses of the communications network device and in response to the validation succeeding, authenticating an identity of the communications network device and an environment of the communications network device comprising the physical network channel media.

In some examples the PUF and/or, when an additional PUF is used, the additional PUF is/are any of: an engineered PUF in the communications network device, result of natural variation of functional components of the communications network device, a hybrid of an engineered PUF and natural variation of functional components.

In some examples coupling the communications network device to the environment comprises using a coupling device and wherein the coupling device is any of: an optical circulator, a beamsplitter, an optical interferometer having a plurality of ports.

In some examples coupling the communications network device to the environment comprises using a first coupling device and coupling the environment to a second communications network device using a second coupling device.

In some examples the coupling device is an optical circulator having at least three ports and where the challenge flows into a first port of the circulator and flows out of a second port of the circulator into the environment, and wherein scattered light from the environment is received into the second port, flows out of a third port of the optical circulator and is routed into the PUF.

In some examples the environment comprises a first sub environment and a second sub environment and wherein the optical circulator receives scattered light from the first sub environment at the second port and receives scattered light from the second sub environment at a third port of the optical circulator.

In some examples the method comprises coupling a plurality of communications network devices to the physical communication channel media, each of the communications network devices containing substantially identical PUFs, and applying the challenge signal to all the communications network devices.

In some examples a group of similar PUFs are prepared and installed in multiple devices which share at least one communication channel, and a similar challenge is sent to each of the multiple devices, and the multiple responses are compared, and an evaluation of whether the multiple devices are connected to the same communication channel is made based on the similarity of the multiple responses.

In some examples the method comprises receiving an ambient signal from other radiation sources in the environment and processing the challenge signal mixed with both the scattered signal and the ambient signal to produce the response.

Another aspect of the disclosed technology comprises a communications network comprising:
a communications network device;
one or more physical network channel media;
a physically unclonable function PUF;
wherein the communications network device is configured to:
accept a challenge signal;
couple all or part of the challenge signal or a transformation of the challenge signal in the form of radiation into the physical network channel media;
allow radiation to scatter between the physical communication channel media and the PUF; and
obtain a response to the challenge by measuring scattered radiation from at least the PUF.

Another aspect of the disclosed technology comprises a physically unclonable function, ‘PUF’, configured to receive a challenge signal, mixed with a scattered signal from an environment of the PUF, and produce a response signal dependent on the challenge signal in response thereto; wherein the PUF comprises a photonic crystal structure of plural dimensionality which is configured to:
be illuminated by an optical input signal which is, or is derived from, the challenge signal; and
responsive thereto, produce an optical output signal dependent on the optical input signal's interaction with the photonic crystal structure, wherein the response signal is, or is derived from, the optical output signal.

Another aspect of the disclosed technology describes obtaining a characteristic response from a communications network device in a communications network environment, the method comprising: accepting, at the communications network device, a challenge signal; coupling all or part of the challenge signal or all or part of a transformation of the challenge signal in the form of radiation into a path comprising one or more physical network channel media of the communications network and a physically unclonable function, ‘PUF’; and obtaining a response to the challenge by measuring scattered radiation from that path.

It will also be apparent to anyone of ordinary skill in the art, that some of the preferred features indicated above as preferable in the context of one of the aspects of the disclosed technology indicated may replace one or more preferred features of other ones of the preferred aspects of the disclosed technology. Such apparent combinations are not explicitly listed above under each such possible additional aspect for the sake of conciseness.

Other examples will become apparent from the following detailed description, which, when taken in conjunction with the drawings, illustrate by way of example the principles of the disclosed technology.

### BRIEF DESCRIPTION OF THE DRAWINGS

FIG. 1 is a schematic diagram of a communications network having a communications network device with a physically unclonable function (PUF);

FIG. 1A is a schematic diagram like that of FIG. 1 and where a challenge signal passes through the same PUF in a forward direction and a reverse direction;

FIG. 1B is a schematic diagram showing division of a challenge signal at a communications network device;

FIG. 2 is a schematic diagram of another example of a communications network where the communications network device has two PUFs;

FIG. 3 is a schematic diagram showing another example of a communications network where there are two PUFs each in a different communications network device;

FIG. 4 is a schematic diagram showing filters used to protect a PUF in a communications network device;

FIG. 5 is a schematic diagram showing a coupling device used to interface between a PUF and an environment of a communications network;

FIG. 5A is a schematic diagram showing use of two coupling devices;

FIG. 6 shows an example where the coupling device is an optical circulator;

FIG. 7 illustrates a method of authenticating identity and environment of a communications network device in a communications network;

FIG. 8 is a schematic diagram of an optical PUF.

The accompanying drawings illustrate various examples. The skilled person will appreciate that the illustrated element boundaries (e.g., boxes, groups of boxes, or other shapes) in the drawings represent one example of the boundaries. It may be that in some examples, one element may be designed as multiple elements or that multiple elements may be designed as one element. Common reference numerals are used throughout the figures, where appropriate, to indicate similar features.

### DETAILED DESCRIPTION

The following description is made for the purpose of illustrating the general principles of the present technology and is not meant to limit the inventive concepts claimed herein. As will be apparent to anyone of ordinary skill in the art, one or more or all of the particular features described herein in the context of one embodiment are also present in some other embodiment(s) and/or can be used in combination with other described features in various possible combinations and permutations in some other embodiment(s).

In applications which involve the security of a communications system, it is advantageous to establish not only the identity of a physical system such as a network element based on attestation that it still has the same internal physical components but also that it has the usual/expected environment. The environment of a communications network device is the network elements (nodes and edges of the communications network) which are neighbouring the communications network device. The network elements may be first hop neighbours (i.e. neighbouring nodes of the communications network that are directly reachable via an edge of the communications network) or any neighbours where backscattered signal from those neighbors is able to reach the communications network device. As mentioned above, attackers may spoof one or more elements in an environment of a communications network device, or may physically relocate the communications network device itself.

The inventor has recognized that an effective approach to characterise a network environment is from a signature of signals received from the network environment which tends to be unique per network environment due to physical and environmental conditions. In the case of an optical communications network the signature of signals comprises backscattered light and optionally direct signals from neighbouring network elements.

In the case of a communications network where electrons travel in solid state materials, the inventor has recognized that an approach to characterise a network environment is from a signature of backscattered electrons and/or direct signals from neighbouring network elements which tends to be unique per network environment.

However, it is not always straightforward to measure and use these signatures in an accurate enough and/or secure enough manner. In the case of optical communications networks, accuracy is weak because the properties of an optical fibre may be easily reproduced or may not be distinctive enough to give a definitive result. Adding identification elements to optical fibres such as Fabry Perot reflective cavities or fibre Bragg gratings is problematic because these identification elements have the potential to be cloned as they lack complexity. There is a risk that a skilled attacker could use exposed optical fibre to measure an optical response and then could spoof a correct response. It is difficult to protect an external optical fibre from modelling attacks as it has many exposed points along it at which an attacker can potentially couple into it using a tap, through which they might probe the fibre transmissions and reflections, e.g. using an optical time-domain reflectometer (OTDR), potentially on an out of band frequency of light which would therefore not be service affecting.

The inventor has found a way to use physically unclonable functions (PUFs) in communications network devices which enables authentication both of an identity of the communications network device and of an environment of the communications network device. A PUF is a device configured to receive a defined input or output challenge signal and provide a physically defined response thereto which serves as a unique identifier.

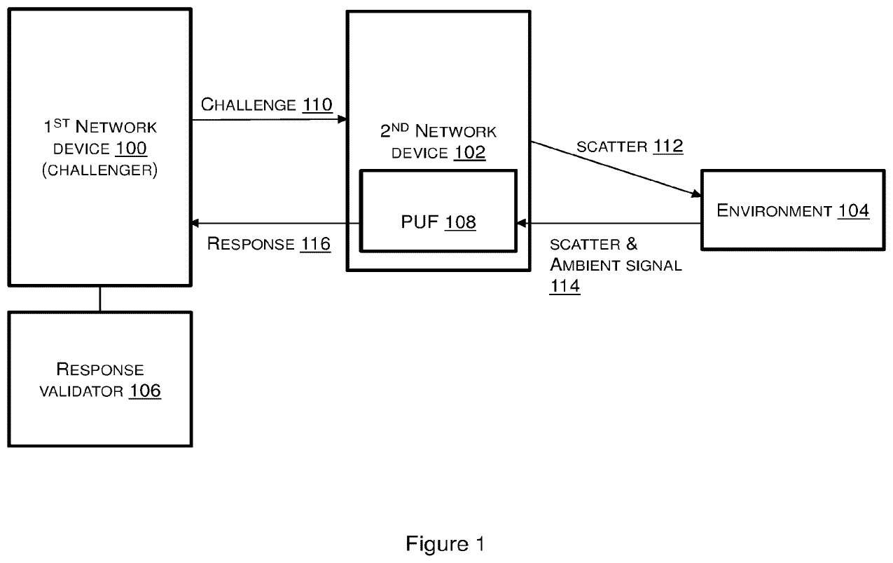

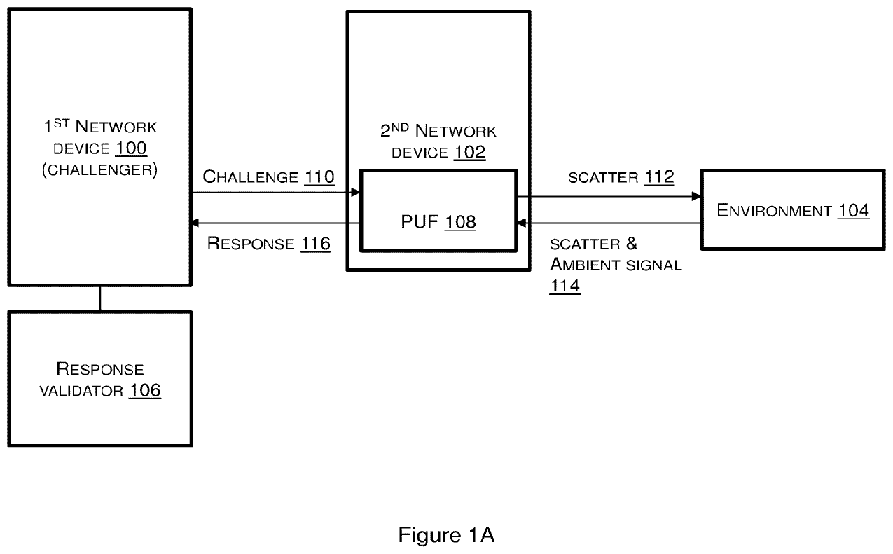

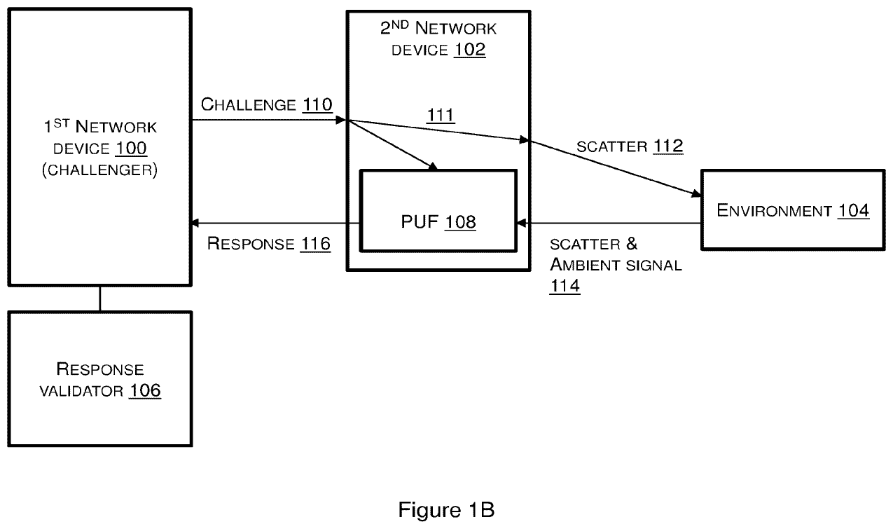

As explained with reference to FIG. 1 a challenge signal is received at a communications network device. The communications network device couples all or part of the challenge signal, or all or part of a transformation of the challenge signal, in the form of radiation, (which is typically electromagnetic radiation and more precisely in the optical communication band with typical wavelength in the range from 300 nm to 2000 nm, depending on application) into one or more physical network channel media of the communications network. The physical network channel media are referred to herein as an environment which is the communications network external to the communications network device. As a result there is some scattered signal from the environment. Radiation is allowed to scatter between the physical network channel media and a PUF. A response to the challenge is obtained by measuring scattered radiation from at least the PUF. The scattered signal is received at the communications network device such as by being routed back to the communications network device or in other ways. The scattered signal mixes or merges with the challenge signal at the communications network device. The mixed/merged signal is used to challenge the PUF and the PUF produces a response. The response is optionally validated and in response to the validation being successful the communications network identity and environment may be successfully authenticated. Alternative uses for the response include storing it, deriving a cryptographic secret from it and obtaining an indication of the integrity and health of the network. In response to the validating being unsuccessful an automated action is taken comprising any of: triggering an alert, isolating the communications network device, shutting down the communications network device.

Merging the response of the environment with the response of a PUF offers advantages over returning separate responses from these separate parts of the communications network, as it couples them together, and provides proof that the communications network device is physically coupled to the expected parts of the network. A further advantage is increase in sensitivity to any change in the environment, because the response typically exploits the wave nature of the radiation (whether electromagnetic or quantum electron waves), and therefore, typically, the response is strongly affected by interference between scattered radiation directly impacting on the PUF from the challenge and radiation from the challenge which is scattered from the environment before impacting on the PUF. This gives greater sensitivity to changes in the environment, on the order of magnitude of one wavelength of the radiation, makes even finer changes in the environment detectable, and makes it even more difficult for a deliberate attacker to make an exact clone of the environment.

In some cases the radiation allowed to scatter into the environment from the communications network device is light and in some cases it is electrons travelling in wavelike form.

FIG. 1 is a schematic diagram of a communications network having a communications network device 102 with a physically unclonable function PUF 108. In an example where the communications network is an optical network the communications network device 102 is any optical communications element and a non-exhaustive list of examples is: transmission (line) card, router with optical interfaces, transponder, muxponder, filter, reconfigurable optical add/drop multiplexor, optical switch, optical fibre, optical splitter, optical amplifier, wave division multiplexer, circulator, laser, light emitting diode. Where the communications network is an electrical communications network a non-exhaustive list of example communications network devices 102 is: a databus on an integrated circuit connecting two regions of a device, a databus on a compound 3D stacked electronic or hybrid electronic/photonic integrated circuit, a databus on a printed circuit board connecting devices, a databus on a backplane connecting modular devices within a chassis.

Where the communications network is an optical network the PUF 108, and/or when an additional PUF is involved the additional PUF, is either an engineered PUF, a PUF which is the result of natural variation of functional components of an optical element, or a hybrid of these. An engineered PUF is an engineered element which has been selected for primary function as a PUF in the device. Using an engineered PUF tends to give better performance although may increase cost as compared with using natural variation of existing functional components of an optical element. Using an engineered PUF also may increase the space taken up as compared with using natural variation of existing functional components of an optical element. In some implementations, the natural variations of functional parts of the communications network device 102 e.g. of optical path delays, splices, connections, changes in waveguide dimensions, bends, cavities, inclusions, changes in density and other physical properties within device waveguides, modulators and interferometers which are part of the normal device function, and which may cause such affects as chromatic dispersion or one or more reflective points or circuits in an photonic integrated circuit, may form the unique character of the PUF.

An engineered PUF is manufactured and a non-exhaustive list of examples is provided by one of, or an ensemble of, any of the following: an optical PUF, a photonic crystal, a quantum electronic device, a quantum tunnelling diode, a quantum resonant tunnelling diode, an Esaki diode, an optical PUF, a photonic integrated circuit, a photonic crystal.

FIG. 1 shows the communications network device 102 connected to an environment 104 which is one or more physical network channel media of a communications network which the communications network device 102 is in. In the case of an optical communications network, the environment 104 to which the PUF in the device is coupled may be a single optical fibre, multiple optical fibres, one or more cores of a multicore optical fibre, or a tree or network of fibres connected with beam splitters, such as a Passive Optical Network (PON). In the case of an electronic system in which the concepts of this invention can be applied the external environment is for example a region of an integrated circuit, stacked integrated circuit, or databus within an integrated circuit which forms a waveguide over which electrons move ballistically and with phase coherence, therefore on a smaller scale reproducing the wavelike properties that can be seen in light at a much larger scale, which results in interference patterns in the response which are unique to the combination of the device PUF and the coupled physical environment, therefore providing a very strong characterising signal.

The environment may be considered as two or more sub environments in some examples as explained in more detail below.

In the case of an optical communications network elements such as Fibre Bragg Gratings may be included in the environment to increase the amplitude of backscattering. This is especially useful where the environment comprises hollow core fibre have negligible back scattering.

In some cases, the environment 104 whether for an optical communications network or an electronic communications network comprises one or more engineered PUFs. In some cases the engineered PUFs are scattering/reflective elements with unique characteristics, e.g. reflectivity as a function of frequency and optical dispersion of different frequencies. The environment 104 may contain one or more photonic crystals, Fibre Bragg Gratings or chirped Fibre Bragg Gratings at points along the optical fibre or waveguide. It may contain frequency selective reflecting elements, which reflect light only of a certain frequency or range of frequencies. If the optical fibre is solid core, these may be inscribed at manufacture, e.g. using a laser. For all types of fibre (solid, or hollow core), these elements may be spliced or connected inline along the fibre. In the case of an optical waveguide, an optical PUF may comprise variations in the material dimensions or a succession of material deposits such as heterogeneous layers, or quantum dots or microdots along the path of the waveguide or device. All types of fibre may be twisted, bent or strained in a unique way to create these features (which may happen during installation). For multicore fibre twisting may be particularly effective in providing unique features, due to induced changes in the coupling between the cores in a single fibre. The natural variations in the environment 104, for example reflective connection points and splices in the fibre, are an additional or alternative unique aspect of the environment 104.

FIG. 1 shows a challenger 100 which is any communications network device capable of sending a challenge signal to the PUF 108. In a non-limiting example the challenger 100 is a communications network node seeking to establish a secure communications channel with the communications network device 102.

FIG. 1 also shows a response validator 106 in communication with the challenger 100. In the example of FIG. 1 the response validator 106 is directly connected to the challenger 100 although that is not essential. In an example the response validator 106 is a web service or a server having software for validating responses. In another example the response validator is implemented in hardware physically proximate the challenger 100 or integral with the challenger 100.

The communications network device 102 is physically connected to the environment 104 using optical fibre or optical waveguides or using wired connection in the case of an electronic communications network. The challenger 100 is connected to the communications network device 102 using any of: optical communications link, wired electrical communications link, wireless communications link. The response validator 106 is in communication with the challenger 100 using any of: optical communications link, wired electrical communications link, wireless communications link.

The communications network device 102 receives a challenge 110 from the challenger 100. The challenge is sent to the communications network device 102 either in raw form or in encoded form. All or part of the challenge from the challenger to the communications network device 102 may be sent over a coherent optical and/or quantum secure channel. The confidentiality of this secure channel may be implemented using optical scrambling using a session key. Optical scrambling is beneficial where the challenge is sent in raw form. In encoded form, all or part of the challenge from the first party to the second party may be sent as a digital representation of the challenge over a digital channel; and where the confidentiality of this secure channel may be implemented using symmetric encryption using a session key.

When using the PUF as part of an active authentication scheme involving challenge response, eavesdroppers are prevented from learning challenge/response pairs and generating a model of the PUF, or at least gaining sufficient information to have a significant chance of being able to predict a correct response to a challenge. To do this it is possible to obscure the challenge and the response when they are transmitted, by transmitting them over a secure channel that provides confidentiality between challenger and communications network device 102. This may be achieved by digital encryption of a representation of the challenge and of the response. The encryption is typically symmetric encryption, e.g. Advanced Encryption Standard (AES) encryption using a Transport Layer Security (TLS) session key established between the two parties during a set up stage. Alternatively though, this may be achieved by physical scrambling of the active challenge over the channel between the two entities. For example optical scrambling based on Optical Code-Division Multiple Access (O-CDMA) or another method, based on a shared symmetric key material.

In the example of FIG. 1 the challenge is accepted at the communications network device 102 and passes through the communications network device 102 without impinging on a PUF 108 in the communications network device 102. The challenge 110 gives rise to radiation which is allowed to scatter 112 into environment 104. Radiation from the environment 104 scatters into a PUF 108 in the communications network device 102 together with any ambient signal from the environment 104, as indicated by arrow 114. The scatter from the environment 104 may be radiation reflecting from the scatter 112. Since the challenge 110 does not pass through PUF 108 on an outbound path from the challenger 100 towards the environment 104 there is no response signal available to the environment 104 which aids security.

The challenger 100 provides the response 116 to a response validator 106, or the response 116 goes direct to the response validator 106. The response validator 106 compares the response to a previous value of the response known to be correct. The comparison may be done using a rule based system or using a machine learning system, or some combination of both. If the validation is successful the environment 104 and the communications network device 102 identity are authenticated. The challenger is then able to establish a secure communication channel with the communications network device 102 using known technology. If the validation is unsuccessful the response validator 106 triggers an automated action such as triggering an alert, isolating the communications network device 102, shutting down the communications network device 102.

In the example of FIG. 1A the arrangement is the same as that of FIG. 1 except that the challenge signal 110 is allowed to impinge on the PUF 108 on its outbound path from the challenger 100 towards the environment 104.

FIG. 1B shows a deployment similar to that of FIG. 1 except that the challenge signal 110 is divided at the communications network device 102. The challenge signal 110 is divided into a first part which impinges on the PUF 108 and a second part 111 which scatters 112 into the environment 104. The dividing of the challenge signal is done using a beamsplitter or in any other suitable way. In the arrangement of FIG. 1B the scatter and ambient signal 114 enters the PUF 108 and the first part of the challenge signal 110 also enters the PUF 108. Interference may occur between the first part of the challenge signal 110 and the scatter and ambient signal 114 creating an interference pattern. In this way the response 116 takes into account the unique combination of the scatter and ambient signal 114 and the first part of the challenge signal 110.

In some examples the PUF 108 is used to derive one or more cryptographic numbers. For example, the response of the PUF 108 may be used as a seed to an algorithm that generates a public and private key. In an example the challenge is stored rather than the derived private key, so that only the holder of the communications network device 102 can generate the private key.

In the case of an optical network, by propagating an optical signal into optical fibre in the environment 104 through an optical PUF element in the device 102 (such as in FIG. 1A), and then coupling the scattered signal into an additional optical PUF in the first device, or a second device, which may be the same optical PUF as originally used (or a clone made at manufacture time of the optical PUF), or an additional different PUF, a unique signature providing confirmation that the device is bound directly to the physical environment is realised.

Where an optical communications network is used, the optical excitation i.e. the optical field may be coherent light e.g. the coherent narrow band output of a laser, which may in some implementations be the light from multiple lasers multiplexed together. In some implementations the excitation is steady state on a timescale which is long compared with the time for the challenge to be fully reflected through all of the PUF and coupled environment, in which case the response may be measured after any initial transient has settled from the response, so that the response is not time dependent over the time window in which it is measured. This excitation may, in some implementations, be modulated in terms of phase, polarisation and amplitude which may increase the diversity of response. In some implementations, the excitation is modulated using a pulse chopper, so that short pulses of light are impinged on the PUF. Short (on the timescale of the scattering time over the PUF and coupled environment) pulses in the challenge will produce a time dependent response, as the pulse is dispersed and scattered by the combination of device PUF and external communication media. In some implementations the short pulses of light are near single-photon level (e.g. with an average amplitude of the order of single photons of light per pulse). As is well known, this can be implemented by attenuating the output of a laser diode. In some implementations the single photon or near single photon pulses are generated by a single photon source, such as a quantum dot based single photon source.

When trains of pulses are used as the excitation in the challenge, then there is a delay time to receiving a scattered train of pulses as digital events at detector(s) in the communications network device 102.

When continuous coherent light is used as the excitation in the challenge, then there is a delay time to receiving scattered coherent light at detectors in the communications network device 102, which may be as digital events, or may include a measurement of amplitude and/or phase. In some implementations detectors in the communications network device 102 are frequency selective (e.g. have a filtered input, for example based on microrings), especially in implementations where the challenge comprises multiple frequencies.

When single photon or near single photons are used, the communications network device 102 has one or more single photon detectors, depending on the design of the coupling of the detectors to the PUF which computes the response. In some implementations to compensate for the dead time of the detector, multiple detectors may be connected at the receiver through one or more beam splitters. Also, in this implementation, quantum effects may be applied in the challenge and response to make it more difficult for an attacker to learn the challenge. For example, the challenge may be transmitted as a raw stream of qubits or qudits prepared on single photon, or near single photon, pulses, and quantum properties such as polarisation, phase or frequency of these qubits may be varied in a manner that is known to the challenger but need not be known to the responder. Preferably the challenger has previously characterised the challenge response function of the PUF and the environment, and uses their knowledge about the preparation of the quantum states in the challenge to choose how to measure the scattered light, or to make inferences based on published data about how the quantum response was measured and digitised, about which parts of the response have been measured in a compatible, information preserving way. However, the resultant response of the coupled device PUF+ system will usually exhibit a degree of unpredictable (to the challenger) variation due to environmental noise and the limitations known from quantum theory of making quantum measurements on a state that has been perturbed by an unknown amount. The challenger can manage this, for example by comparing the current response with the response to historic similar challenges to determine statistical similarity within a threshold which is deemed acceptable due to environmental noise and quantum measurement outcome variations and compatibility with previous responses and therefore validate or invalidate the response. Advantageously, an attacker will not be able to fully measure the challenge (or response if also transmitted as a raw signal back to the challenger) by eavesdropping the channel over which it is sent, because unknown quantum states cannot be fully measured without disturbing the states.

In the example of FIG. 1 there is one PUF. Thus the response may on first excitation for a very short initial time period be dominated by the direct response from the PUF on the device, but after the time for light to travel into the environment 104 and be reflected back into the PUF has elapsed, the response will be a function of both the PUF and the environment 104. If the excitation remains coherent throughout this time period, the response will include optical interference between the directly impinging excitation and the part of the excitation (that originated at an earlier time) which is scattered from the environment, which is in some cases an external waveguide, back into the PUF on the device.

In some variations of FIG. 1 there is a plurality of communications network devices each containing a PUF, and all of the PUFs are substantially identical, and are coupled to the same communication channel media in a similar way. For example, the multiple devices may be multiple optical communication transmission cards all multiplexed onto the same optical fibre. The same challenge may be applied to each device, therefore testing (by comparing the responses) that all the devices are coupled to the same communication channel. To avoid mixing the results, the challenges may be applied to different devices at slightly different times, for example the raw challenge signal may be split and time delayed using an optical splitter, or if it was received in encoded form it may be generated at different times for each device in the group. Advantageously, this provides a method of verifying (through statistical comparison of the plurality of responses to the same or a similar challenge) that all devices are coupled to the same communication medium.

In various examples a challenge signal is accepted at the communications network device, all or part of the challenge signal or all or part of a transformation of the challenge signal in the form of radiation are coupled into a path comprising one or more physical network channel media of the communications network and a PUF, and a response is obtained to the challenge by measuring scattered radiation from the path.

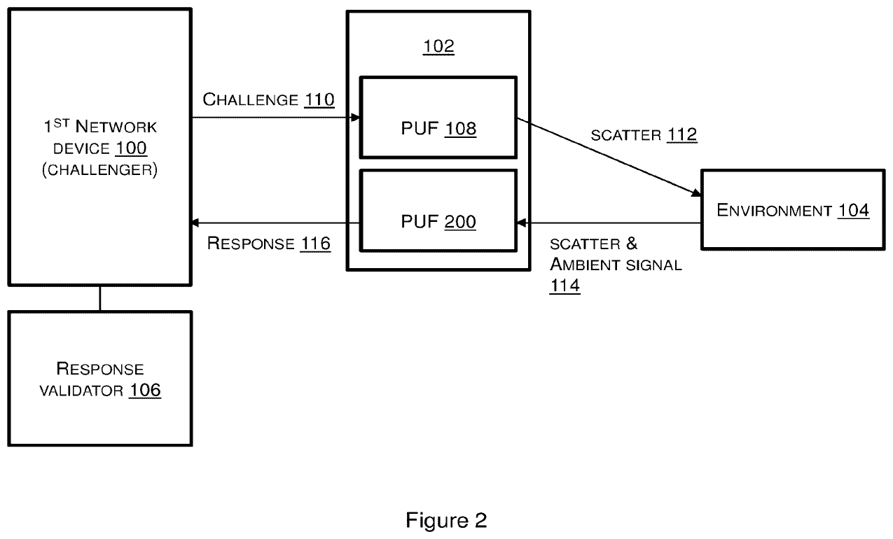

FIG. 2 is a schematic diagram of another example of a communications network. The example is the same as the arrangement of FIG. 1 except that the communications network device 102 has two PUFs 108, 200 both inside the communications network device 102. In this example the PUF 108 which receives the challenge 110 is independent of the PUF 200 which generates the response 116. The two PUFs may have been manufactured so as to be substantially identical such as described in White et al. (WO2022/096403 A1). Groups of two or more manufactured cloned PUFs may be created by slicing a one dimensional 1D layered solid state structure transverse to the plane of the layers, creating similar 1D PUFs that can be placed inline on a waveguide, for example using a manufacturing technique of stacking integrated circuits.

In some variations, a transformation of the challenge 110 in the form of radiation, where the transformation in some variations is coupled into one or more physical network channel media of the communication network, is obtained by scattering the radiation through an additional PUF 108 to the PUF 200 that generates the response 116.

A benefit of using two PUFs 108, 200 is that it provides evidence that two parts of a device in a physical network environment are untampered with at the physical layer. For example, one PUF may be within a network control unit, and another additional PUF may be within an optical transmission card, and both PUFs may be coupled to the same optical channel, so that light from the first PUF can be coupled to the additional PUF via back scattering on the optical channel (either by direct backscattering, or by careful use of coupling devices such as circulators as described elsewhere).

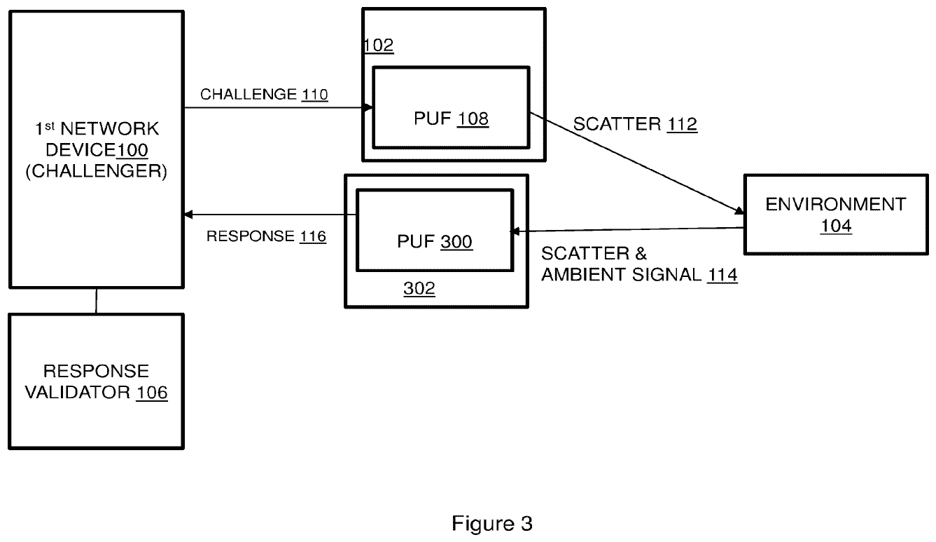

FIG. 3 is a schematic diagram showing another example of a communications network where there are two PUFs 108, 300 but this time each in a different communications network device; otherwise the arrangement is the same as that of FIG. 2. Since the PUFs 108, 300 are in different devices they may be physically separated allowing greater flexibility of communications network layout. A benefit of this arrangement is that it provides evidence that two devices on a physical network environment are the expected devices and are connected over a channel which is as expected and untampered with at the physical layer.

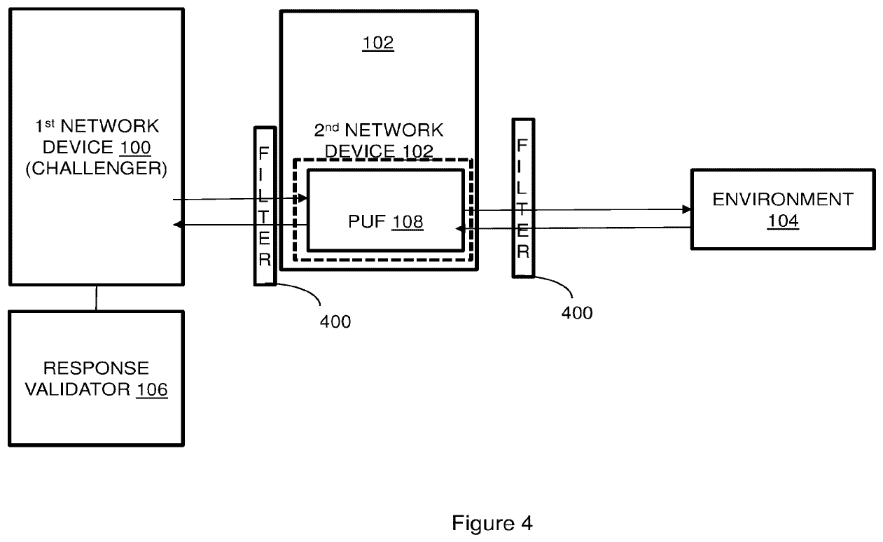

FIG. 4 is a schematic diagram showing filters 400 used to protect a PUF 108 in a communications network device 102. The arrangement is similar to that of FIG. 1 but the PUF is protected from probing by an attacker using out of bound signals by interposing a filter 400 between the PUF and the communications network. Filters 400 may be designed (e.g. on photonic integrated circuit, PIC) to protect the PUF from probing by an attacker using out of bound signals. In FIG. 4 the PUF 108 is also protected physically as indicated by the dotted box surrounding the PUF 108. The physical protection is any one or more of: enclosing the PUF in a secure element, enclosing the PUF in a metal screen, physically protecting connection points of the PUF, adding optical isolators to connection points of the PUF. The PUF 108 is preferably enclosed within a secure element which will include physical protection of the PUF 108 from inspection and protection of the PUF 108 from intrusive measurements. The secure element may include a metal (e.g. foil in resin) screen and protection of any optical or electrical channels into the PUF from external coupling (e.g. by physically protecting connection points, or by adding e.g. optical isolators to prevent incoming signals, or to block reflections).

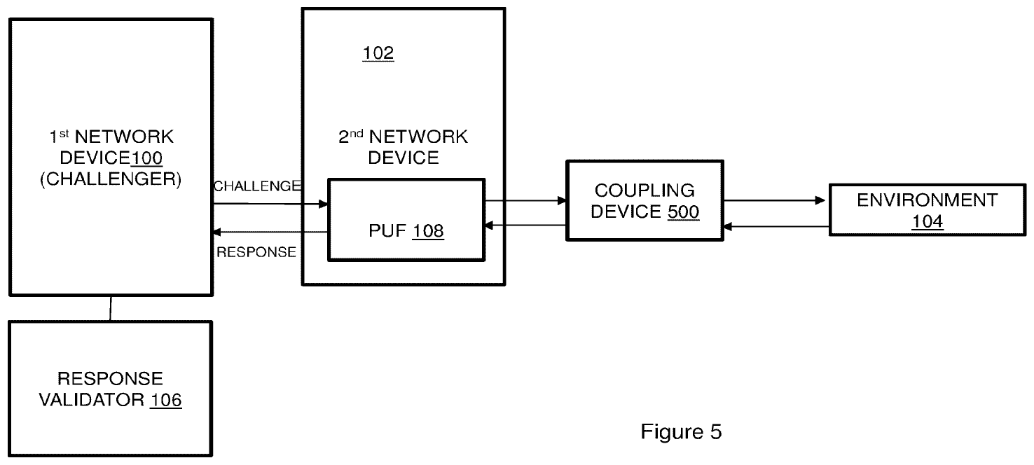

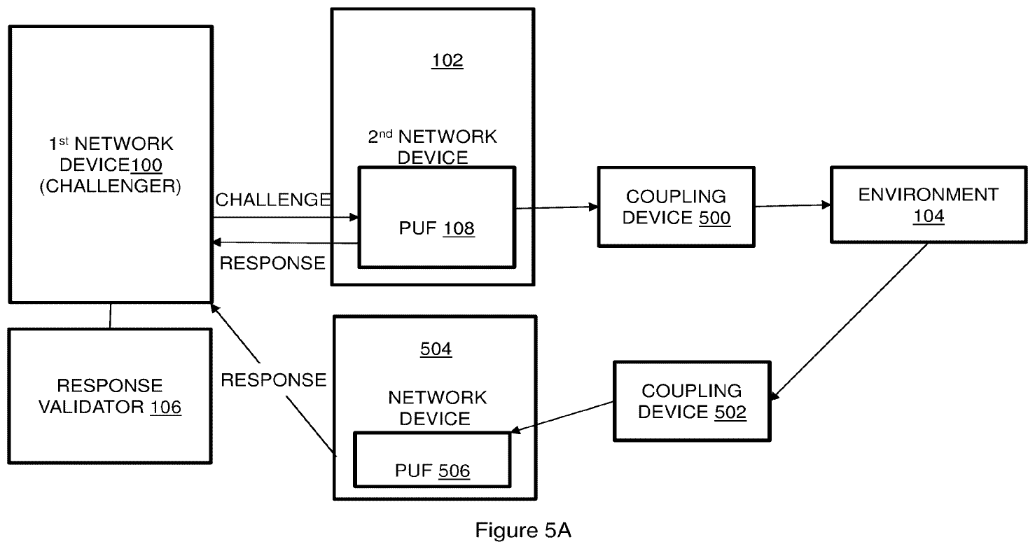

FIG. 5 is a schematic diagram showing a coupling device 500 used to interface between a PUF and an environment 104 of a communications network. The arrangement may be the same as any of FIGS. 1 to 4; that is FIG. 5 can be adapted to any of the arrangements of FIGS. 1 to 4 by adding the coupling device 500 to those arrangements. The coupling device 500 is any of: an optical circulator, a beamsplitter, an optical interferometer having a plurality of ports. In some implementations the PUF 108 is optically switched onto the environment 104, during which time the ambient light sources in the environment 104 may be isolated from the parts of the communications network device 102 receiving the optical PUF challenge. In other implementations a beam splitter is used to mix the challenge into the environment 104. It is possible that the environment 104 contains other light sources which will be coupled to the PUF 108 through the coupling device 500 and contribute to the characteristic response.

Optical channel(s) in the environment 104 that are coupled to the PUF(s) 108 may carry one or more communication channels. In some implementations the communication itself is the excitation to the PUF. In some implementations a beam splitter extracts a fraction of the challenge signal onto the communication channel and passes it through the PUF 108 in the communications network device 102.

FIG. 5A is similar to FIG. 5 but where there are two coupling devices 500, 502 and two communications network devices 102, 504 in addition to the challenger 100. One coupling device 500 is on an outbound path from the challenger 100 towards the environment 104. Another coupling device 502 is on an inbound path from the environment 104 to a further communications network device 504. In this arrangement the challenger 100 receives a response from a PUF 108 in the communications network device 102 and from an additional PUF 506 in the further communications network device 504.

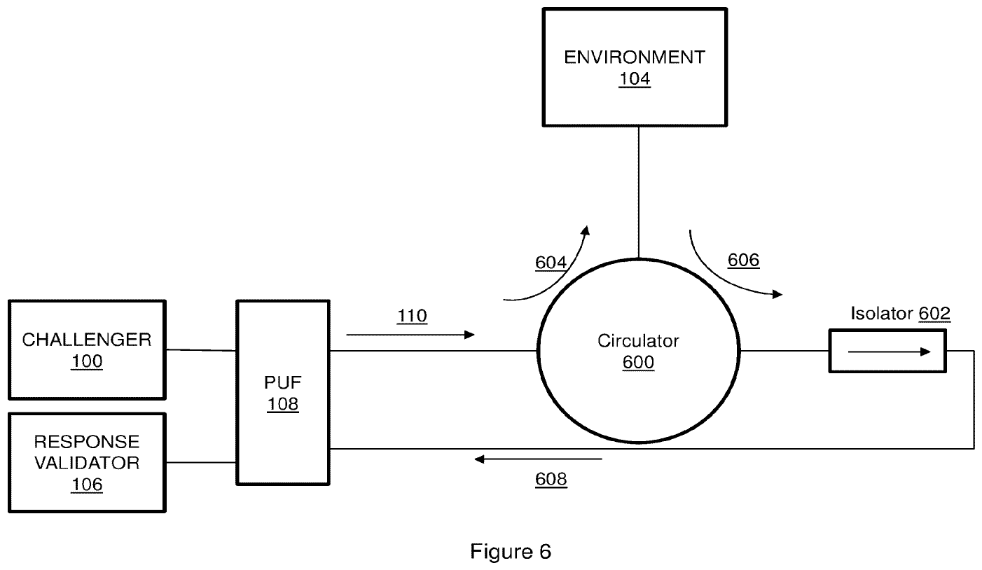

FIG. 6 shows an example where the coupling device 500 is an optical circulator 600. An optical circulator is a standard device in optical networking which has the property that light which flows into one port will flow out of the next port; whereas light that flows into that next port will flow out of the following port.

Optical circulators have three or more ports. When integrating the environment 104 with an optical PUF 108, a challenge 110 flows onto a local PUF 108 (e.g. engineered PUF) through one port of the circulator 600. The second port of the circulator 600 carries a first response 604 from the local PUF 108 outward onto the environment 104 (e.g. optical waveguide or fibre, or freespace link). Backscattered light 606 from this environment will flow back into the second port and out of the third port. By routing the signal from the third port back towards the optical PUF 108 (along arrow 608), the signal will interact with couplers and/or detector(s) around the PUF 108. If the signal is received back in coherent form, then interference effects and even quantum effects (in the case that the challenge signal is a functional quantum optical signal—for example produced by a highly attenuated laser) are possible in the altered response from the PUF.

It will be apparent that a circulator with further ports can be used if there are a plurality of sub environments to be taken into account. For example, using a first two ports A and B, a first sub environment can be mixed into the signal used to generate the response; and using port B and a further port C, a second sub environment can be mixed with the signal used to generate the response.

In an example the coupling device is an optical circulator having at least three ports and where the challenge flows onto the PUF through a first port of the circulator and flows out of a second port of the circulator into the environment, and wherein backscattered light from the environment is received into the second port, flows out of a third port of the optical circulator and is routed into the PUF.

In an example the environment comprises a first sub environment and a second sub environment and wherein the optical circulator receives backscattered light from the first sub environment at the second port and receives backscattered light from the second sub environment at a third port of the optical circulator.

In the example of FIG. 6 the radiation from the PUF caused by the challenge signal impinging on the PUF is coupled into a first port of a circulator.

At 604, the radiation flows out of the 2nd port of the circulator and into an external environment 104. At 606 the backscattered light from the environment, which is a waveguide in some cases, flows into the 2nd port of the circulator and out of the 3rd port of the circulator. The light from the 3rd port of the circulator is preferably protected by flowing through an isolator 602. This prevents an attacker from receiving a reflected signal from any light that is shone in from the environment, which is in some cases an external waveguide; and therefore helps to prevent the attacker from building a model of the PUF.

At 608 back scattered light from the environment, which is in some cases an external waveguide, is coupled back onto the original PUF, where it mixes with the current excitation of the PUF, and will form a temporal variation to the response profile of the PUF.

In an example, a group of similar PUFs are prepared and installed in multiple devices which share at least one communication channel, a similar challenge is sent to each of the multiple devices, the multiple responses are compared, and an evaluation of whether the multiple devices are connected to the same communication channel is made based on the similarity of the multiple responses.

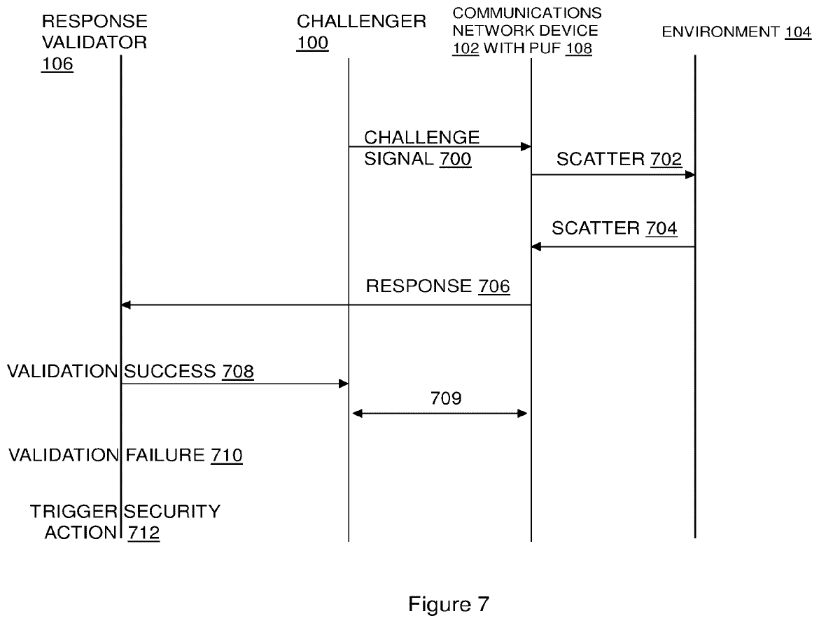

FIG. 7 illustrates a method of authenticating identity and environment of a communications network device in a communications network. FIG. 7 shows a response validator 106 as a vertical line, a challenger 100 as a vertical line, a communications network device 102 with a PUF 108 as a vertical line and an environment 104 as a vertical line. Arrows between the lines represent signals sent between the entities. The relative vertical position of the arrows represents chronological order.

The challenger 100 generates a challenge which is normally a signal 700 which has a time and/or frequency varying profile, and sends it to the communications network device 102. In some versions of the implementation part of the challenge may involve sending a PUF configuration (for example setting the position of optical switches or the temperature of thermal elements within the PUF) to the PUF 108 and/or any additional PUFs associated with the communications network device 102.

The communications network device 102 accepts the challenge. In an example the communications network device accepts the challenge by allowing the challenge to impinge on the internal PUF 108. This may happen automatically, or there may be a gatekeeping function in which the communications network device 102 checks some properties of the challenge before generating it from its representation (if the challenge is sent as an encoded representation) or optically switching it onto a path towards the internal PUF 108 (if the challenge is sent in raw form.)

The internal PUF 108 is coupled to the environment 104 such as an external optical fibre as described above. Backscattering occurs 702-704 and backscatter 704 together with any ambient signal from the environment 104 travels from the environment 104 to the communications network device 102.

The backscatter and ambient signal mixes with the challenge signal being directly impinged from the challenger 100. The mixed signal is applied to the PUF 108 and produces a response. The resulting diversity of response is particularly effective in typical implementations where there is optical coherence (or quantum optical coherence) between the backscattered light and the original challenge.

The response 706 is coupled out of the PUF 108 back to the challenger or direct to the response validator 106 as shown in FIG. 7. The response is measured and transmitted as a digital representation of the response, or transmitted raw as an optical (or quantum optical) signal.

This response may be statistically processed by the response validator 106 to take account of fluctuations in the environment, for example it may be time averaged, and other statistics such as standard deviation may be used. However in a more sophisticated implementation the response validator may operate over a rolling window of time over which responses are collected. A machine learning system such as a classifier or deep learning system may be part of the system used to classify whether or not a situational response from the PUF 108 is within the normal bounds of the system over a normal time period (e.g. over a second, hour, day, week or month) or whether the response to a challenge has changed significantly. In some classifiers, compensation for the time of day and week and year will be made, to allow for typical diurnal and seasonal patterns by comparing with historical response data classified at a similar time.

FIG. 7 illustrates both possible validation outcomes following receipt of the response 706 by the response validator 106. Where the response validator 106 determines validation as successful it sends a validation success message 708 to the challenger 100 and in response a secure communications channel 709 may be established between the challenger 100 and the communications network device 102. In the case the response validator 106 determines validation as unsuccessful (i.e. validation failure 710) the response validator triggers 712 a security action such as sending an alert, automatically isolating the communications network device 102, automatically shutting down the communications network device 102 or other security action.

In some cases the PUF 108 of the communications network device 102 may act as an optical scrambler for the complete communication channel signal i.e. the mixture of the backscattering, ambient signal and the challenge signal. In which case recovering the descrambled communication channel may involve a digital signal processing operation which is trained to the dispersion of the combined device PUF 108 plus environment signal. Changes to a digital signal processing DSP function (e.g. the weights of a neural network or the parameter-tuned chain of DSP functions such as Fourier Transforms) may be used to discriminate between a normal response and a response deemed to be abnormal/beyond normal threshold of variation.

In some implementations the challenge and or response is transmitted digitally and is optically generated/measured at the communications network device 102 which holds the PUF 108. If the challenge and or response is transmitted digitally, this is over a channel which is secured to provide message integrity and message authentication e.g. using public key infrastructure PKI or Web of Trust to provide digital signatures that are bound to an identity, and using a TLS session bound to these identities to provide message integrity.

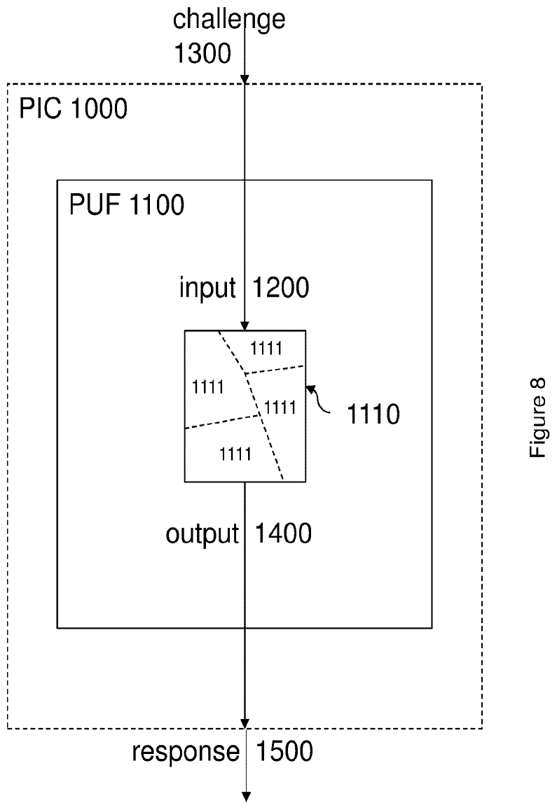

A non-limiting example of an optical PUF is now given with reference to FIG. 8.

As schematically illustrated in FIG. 8, a PUF 1100 comprises a photonic crystal structure 1110 which is configured to be illuminated by an optical input signal 1200 which is, or is derived from, a challenge signal 1300. An optical output signal 1400 is produced by the PUF dependent on the optical input signal 1200's interaction with the photonic crystal structure 1110. The response signal 1500 is, or is derived from, the optical output signal 1400. Such a PUF can be integrated into a communication network. If the communication network is optical then no electro-optic signal conversion is required. The PUF 1100 is configured to receive a challenge signal, mixed with a scattered signal from an environment of the PUF 1100, and produce a response signal dependent on the challenge signal in response thereto. A benefit of using PUF 1100 in the arrangements described in FIGS. 1 to 7 is that it is sensitive to any optical interference in the optical input signal 1200.

The optical input signal 1200 can be a coherent pulse, with well-defined phase and frequency profile. It can for example originate from a laser diode or other source, such as a single photon source. Alternatively, two or more sources may provide the optical input signal 1200, which can be locked to each other, i.e. with each source emitting light which is coherent with respect to the other source(s). For example, coherent light from the same laser can be split along two or more paths (e.g. using a beamsplitter), then directed towards different apertures from which it is incident onto the photonic crystal structure. Optionally each path can be subject to different optical modulation, e.g. temporal pulse-shaping, phase modulation or spectral filtering (which may also be time variant).

In some implementations the optical input signal 1200 can be optically (spatially) expanded (e.g. using a lens), polarised, and/or collimated before it is incident onto the photonic crystal structure 1110. Polarising the light aids uniformity and reproducibility of results, as the behaviour of the PUF may be polarisation sensitive and easier to characterise for a single polarisation. Collimation can similarly improve reproducibility.

In some implementations a path of the optical signal through the PUF 1100 can comprise an input polariser in advance of the photonic crystal structure 1110 and an output polariser, which is not aligned with the input polariser, following the photonic structure 1110. In this way the optical output signal will depend in part on polarisation dependent properties such as the birefringence of the photonic crystal structure. Birefringence can thus be used as an additional variable in PUF design, leading to stronger PUFs.

In some scenarios there is a risk that environmental conditions which result in physical modification of the PUF (e.g. via thermal expansion) and/or disturbances to the challenge and/or optical input signals (e.g. small phase or polarisation changes or chromatic dispersion) may change the response of the PUF 1100 to the challenge, increasing the variability error between the expected response and the response provided by the PUF 1100. The variability error tends to be worse the more complex the PUF, therefore it can be a particular issue for the types of multi-dimensional photonic crystal structure based PUFs described herein, especially those which make use of multiple light propagation properties (polarisation, frequency etc.) for their intentional challenge-response variability. To mitigate against this issue, mechanisms for thermal stabilisation of the device, for example by Peltier cooling, and/or electromagnetic shielding, and/or polarisation and/or collimation may be implemented on the PUF 1100. Alternatively or additionally, the PUF may comprise sensors to enable measurement of parameters which could unintentionally vary the response such as temperature, polarisation, phase or changes in optical path length (e.g. as measured by interferometry). The measurement results can then be used by the PUF to actively and dynamically self-calibrate, if components are provided for doing so. Alternatively or additionally, the measurement results can be taken into account in the determination of whether the response signal is as expected.

The optical output signal 1400 can be measured by one or more detectors, which can for example be optical detector arrays, such as photodiode arrays, either comprised in the PUF or in one or more other devices the PUF communicates the optical output signal to. If the optical output signal is digitised to produce the response signal 1500 then the digitisation can be of the optical output signal intensity as a function of time since the challenge signal 1300 is sent, allowing the unique output (determined by factors such as interference, chromatic dispersion and latency) of the PUF to be properly characterised.

The schematic illustration of FIG. 8 shows the optical output signal 1400 exiting the photonic crystal structure 1110 at a location diametrically opposed to the location the optical input signal 1200 enters the photonic crystal structure 1110, with no other components of the PUF 1100 changing the optical signal's course, such that the PUF 1100 is shown as entirely transmissive. In some implementations however the photonic crystal structure 1110 and/or other components of the PUF 1100 (and/or a PIC 1000 in which it is comprised) may change the course of the optical signal and/or split and/or recombine it. In this way, the PUF 1100 can be partially transmissive and partially reflective, or entirely reflective.

A photonic crystal is an optical medium comprising a periodically repeating pattern of elements or motifs configured to scatter light, where the repetition periods are of the order of optical wavelengths, for example 20 nm to 3000 nm, or more commonly 200 nm to 1500 nm, for example 800 nm may be a suitable choice to work with typical optical fibre telecommunications (of wavelength 1600 nm) while 400 nm may be more appropriate to work with typical free space optical communications (of wavelength 800 nm). The repetition periods are generally on the scale of equal or less than the wavelength of the light they are intended to work with (whether visible, ultraviolet or infrared). The motifs can for example be micro-dots, micro-rings, micro-polygons or another structured shape, which can be point-like, such as micro-snowflakes, or have a different shape which need not have any inherent symmetries.

The photonic crystal structure proposed is of plural dimensionality. That is, the photonic crystal structure can comprise one or more photonic crystalline grains or regions, each characterised by a periodic lattice extending in two or three dimensions. (Grain/region size is generally larger than the wavelength of the optical input signal, for example of order ten times or larger than the longest wavelength present in the optical input signal, e.g. 2 μm to 500 μm.) An example of a photonic crystal structure comprising a plurality of three dimensional photonic crystalline grains or regions is a natural or artificial opal.

Alternatively, the photonic crystal structure can comprise two or more one dimensional periodic gratings, optically coupled so as to form a structure having a logical dimensionality of two or more, in the sense that the connectivity of the structure can be described by a planar or higher dimensional graph. For example, such one-dimensional gratings could be layered on top of or adjacent one another, or optically coupled by waveguides and/or other optical components. In general, the photonic crystal structure can have a higher logical dimensionality than the dimensionality of each of a plurality of periodic arrays (e.g. lattices or gratings) it comprises, provided those arrays are optically coupled to one another in a suitable way. For example, waveguides could couple the arrays to one another in such a way that the relationships between optical parameters such as phase, polarisation and frequency of light at different positions on the output interface of one array are preserved at corresponding positions on the input interface of the next. (This could for example be achieved by two adjacent arrays on the optical input signal's path through the PUF being coupled by a plurality of waveguides all of the same length, which could suitably be an integer multiple of the optical input signal wavelength where a monochromatic optical input signal is used.) Alternatively, those relationships could be transformed in a regular way, for example the phase could be advanced by an amount which depends on distance along the respective interface. (This could for example be achieved by two adjacent arrays on the optical input signal's path through the PUF being coupled by a plurality of waveguides which increase in length when considered sequentially along the respective interface.) In some implementations, coupling waveguides may overlap each other, for example on a multi-layered PIC. Overlapping waveguides could be separated by an optically isolating material, or could be intentionally optically coupled to one another. In some implementations, coupling waveguides may transmit light bidirectionally (i.e. transmitting reflections).

Any reference to ‘an’ item refers to one or more of those items. The term ‘comprising’ is used herein to mean including the method blocks or elements identified, but that such blocks or elements do not comprise an exclusive list and an apparatus may contain additional blocks or elements and a method may contain additional operations or elements. Furthermore, the blocks, elements and operations are themselves not impliedly closed.

The steps of the methods described herein may be carried out in any suitable order, or simultaneously where appropriate. The arrows between boxes in the figures show one example sequence of method steps but are not intended to exclude other sequences or the performance of multiple steps in parallel. Additionally, individual blocks may be deleted from any of the methods without departing from the scope of the subject matter described herein. Aspects of any of the examples described above may be combined with aspects of any of the other examples described to form further examples without losing the effect sought. Where elements of the figures are shown connected by arrows, it will be appreciated that these arrows show just one example flow of communications (including data and control messages) between elements. The flow between elements may be in either direction or in both directions.

Where the description has explicitly disclosed in isolation some individual features, any apparent combination of two or more such features is considered also to be disclosed, to the extent that such features or combinations are apparent and capable of being carried out based on the present specification as a whole in the light of the common general knowledge of a person skilled in the art, irrespective of whether such features or combinations of features solve any problems disclosed herein. In view of the foregoing description it will be evident to a person skilled in the art that various modifications may be made within the scope of the invention.

1-17. (canceled)

18. A method of determining whether a communications network device is directly physically coupled to a particular physical communications network environment by:
accepting, at the communications network device, a challenge signal;
coupling all or part of the accepted challenge signal or all or part of a transformation of the accepted challenge signal in the form of radiation into an environment external to the communications network device comprising one or more physical network channel media of the communication network;
allowing radiation to scatter between said environment external to the communications network device and a physically unclonable function, ‘PUF’ in the communications network device in response to said coupling;
receiving an ambient signal from other radiation sources in the environment external to the communications network device;
processing the challenge signal mixed with both the scattered signal and the ambient signal to produce a response to the challenge;
obtaining the response to the challenge by measuring scattered radiation from at least the PUF; and
validating the response by comparing the response to a previously characterised challenge response function of the communications network device in the particular physical communications network environment.

19. The method of claim 18 where the radiation coupled into the environment external to the communications network device is all or part of a transformation of the challenge signal in the form of radiation, and wherein the transformation of the challenge signal in the form of radiation is obtained by scattering the radiation through the PUF before the challenge signal impinges on the environment external to the communications network device.

20. The method of claim 18 where the radiation coupled into the environment external to the communications network device is all or part of a transformation of the challenge signal in the form of radiation, and wherein the transformation of the challenge signal in the form of radiation is obtained by scattering the radiation through an additional PUF.

21. The method of claim 18 where the challenge signal is split into at least two parts, a first part of which is directly coupled to the PUF, and a second part of which is coupled to the environment external to the communications network device, and the method comprises a scattered signal from the environment external to the communications network device being coupled to the PUF.

22. The method of claim 21 wherein the first part of the challenge signal and scattering from the second part are coherent, and wherein the response is influenced by classical or quantum interference between the first part of the challenge signal and scattering from the second part.

23. The method of claim 18 comprising, in response to the validation succeeding, authenticating an identity of the communications network device and the particular physical communications network environment.

24. The method of claim 18 wherein:
(i) the PUF and/or,
(ii) when the method, the additional PUF
is/are any of: an engineered PUF in the communications network device, result of natural variation of functional components of the communications network device, and a hybrid of an engineered PUF in the communications network device and natural variation of functional components of the communications network device.

25. The method of claim 18 comprising coupling the communications network device to the environment external to the communications network device using a coupling device and wherein the coupling device is any of: an optical circulator, a beamsplitter, an optical interferometer having a plurality of ports.

26. The method of claim 18 comprising coupling the communications network device to the environment external to the communications network device using a first coupling device and coupling the environment external to the communications network device to a second communications network device using a second coupling device.

27. The method of claim 25 wherein the coupling device is an optical circulator having at least three ports and where the challenge flows into a first port of the circulator and flows out of a second port of the circulator into the environment external to the communications network device, and wherein scattered light from the environment external to the communications network device is received into the second port, flows out of a third port of the optical circulator and is routed into the PUF.

28. The method of claim 27 wherein the environment external to the communications network device comprises a first sub environment and a second sub environment and wherein the optical circulator receives scattered light from the first sub environment at the second port and receives scattered light from the second sub environment at a third port of the optical circulator.

29. The method of claim 18 comprising coupling a plurality of communications network devices to the environment external to the communications network device, each of the communications network devices containing substantially identical PUFs, and applying the challenge signal to all the communications network devices.

30. The method of claim 18 in which a group of similar PUFs are prepared and installed in multiple devices which share at least one communication channel, and a similar challenge is sent to each of the multiple devices, and the multiple responses are compared, and an evaluation of whether the multiple devices are connected to the same communication channel is made based on the similarity of the multiple responses.

31. A communications network comprising:
a communications network device;
an environment external to the communications network device comprising one or more physical network channel media of the communication network;
a physically unclonable function, ‘PUF’ in the communications network device;
wherein the communications network device is configured to:
accept a challenge signal;
couple all or part of the accepted challenge signal or all or part of a transformation of the accepted challenge signal in the form of radiation into the environment external to the communications network device;
allow radiation to scatter between said environment external to the communications network device and the PUF in response to said coupling;
receive an ambient signal from other radiation sources in the environment external to the communications network device;
process the challenge signal mixed with both the scattered signal and the ambient signal to produce a response to the challenge;
obtaining the response to the challenge by measuring scattered radiation from at least the PUF; and
validating the response by comparing the response to a previously characterised challenge response function of the communications network device in the particular physical communications network environment.

32. A physically unclonable function, ‘PUF’, configured to receive a challenge signal, mixed with a scattered signal from an environment of the PUF, and produce a response signal dependent on the challenge signal in response thereto, the response being for authenticating identity of the PUF and authenticating the environment; wherein the PUF comprises a photonic crystal structure of plural dimensionality which is configured to:
be illuminated by an optical input signal which is, or is derived from, the challenge signal; and
responsive thereto, produce an optical output signal dependent on the optical input signal's interaction with the photonic crystal structure, wherein the response signal is, or is derived from, the optical output signal.
